(19) United States
(12) Patent Application Publication
(10) Pub. No.: US 2005/0096139 A1
(43) Pub. Date: May 5, 2005

(54) Protective sleeve for drive coupling

(75) Inventors: Donald S. Hensel, Rochester, NY (US); Gary E. Nichols, Fairport, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/956,457

(22) Filed: Oct. 1, 2004

Related U.S. Application Data
(60) Provisional application No. 60/515,795, filed on Oct. 30, 2003.

(51) Int. Cl. F16D 3/04

(52) U.S. Cl. 464/104

(57) ABSTRACT

A protective sleeve of a coupling for drivingly connecting a first shaft and a second shaft. The coupling includes a central disk capable of sliding relative to the first shaft and the second shaft so as to provide a uniform output speed even when the first shaft and second shaft are misaligned. The protective sleeve extends between, and is in sealing relation with, the first shaft and the second shaft, and encapsulates the central disk to shield the central disk from contamination. The protective sleeve is formed of a flexible material, such as polyurethane, to accommodate any misalignment between the first shaft and the second shaft.

### FIELD OF THE INVENTION

This invention relates in general to a coupling in a drive train for first and second shafts where the axes of the first and second shafts may not be coincident, and more particularly to a drive coupling accommodating first and second shafts which may not have coincident axes and having a protective sleeve so that the drive coupling may be provided for shafts in an unfriendly environment.

### BACKGROUND OF THE INVENTION

In many drive train applications, the various connecting shafts within the drive train may have axes that do not remain constantly coincident. When misaligned shafts (i.e., shafts that are off-set or have non-coincident axes) are intended to transmit motion therebetween, the result may be wobble and/or non-uniform speed output. In certain applications, constant non-fluctuating speeds are essential to proper and acceptable operation. Flexible type couplings have been used to accommodate for misaligned shafts in a drive train. However, flexible couplings add substantial expense to drive trains in which they are employed, and exhibit a limited ability to maintain uniform constant speed output between misaligned shafts.

Another type coupling, which has been successfully used in drive trains with misaligned shafts to accommodate shaft misalignment while maintaining uniform speed over a wide range, is referred to as a double slider or Oldham coupling. In this coupling a central disk is mounted between two hubs respectively fixed to the two shafts to be drivingly connected. The center disk has channels or projections formed on opposite sides of the disk. The channels or projections are oriented at approximately 90° from each other. The channels or projections are receivable with complimentary mating surfaces in the respective hubs. Radial sliding movement of the central disk relative to the complimentary surfaces of the hubs, as the first shaft drives the second shaft, accommodates for misalignment and maintains uniform speed output.

Drive trains with axes that do not remain constantly coincident are often found in unfriendly (contamination prone) environments. It has, however, been found that use of double slider/Oldham couplings is limited to environments that are not subject to contamination, particularly particulate contamination. Particulate contamination can collect on the mating surfaces between the central disk and the hubs, which may cause binding or sticking. Clearly binding or sticking is objectionable in that it will prevent uniform speed output. Therefore, it is desirable to provide a coupling that accommodates for shaft misalignment and maintains uniform speed output, and that can efficiently function in a contaminated environment.

### SUMMARY OF THE INVENTION

In view of the above, this invention is directed to a protective sleeve of a coupling for drivingly connecting a first shaft and a second shaft. The coupling includes a central disk capable of sliding relative to the first shaft and the second shaft so as to provide a uniform output speed even when the first shaft and second shaft are misaligned. The protective sleeve extends between, and is in sealing relation with, the first shaft and the second shaft, and encapsulates the central disk to shield the central disk from contamination. The protective sleeve is formed of a flexible material, such as polyurethane, to accommodate any misalignment between the first shaft and the second shaft.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is an exploded view, in perspective, of the drive coupling including the protective sleeve according to this invention; and

FIG. 2 is a view, in cross-section, of the drive coupling including the protective sleeve according to this invention.

### DETAILED DESCRIPTION OF THE INVENTION

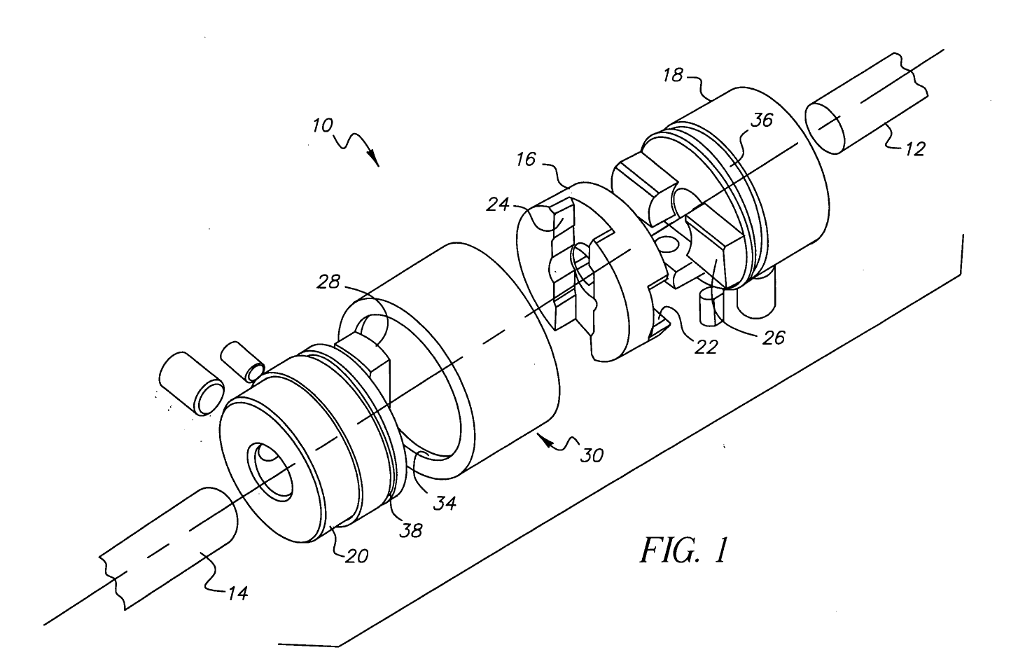

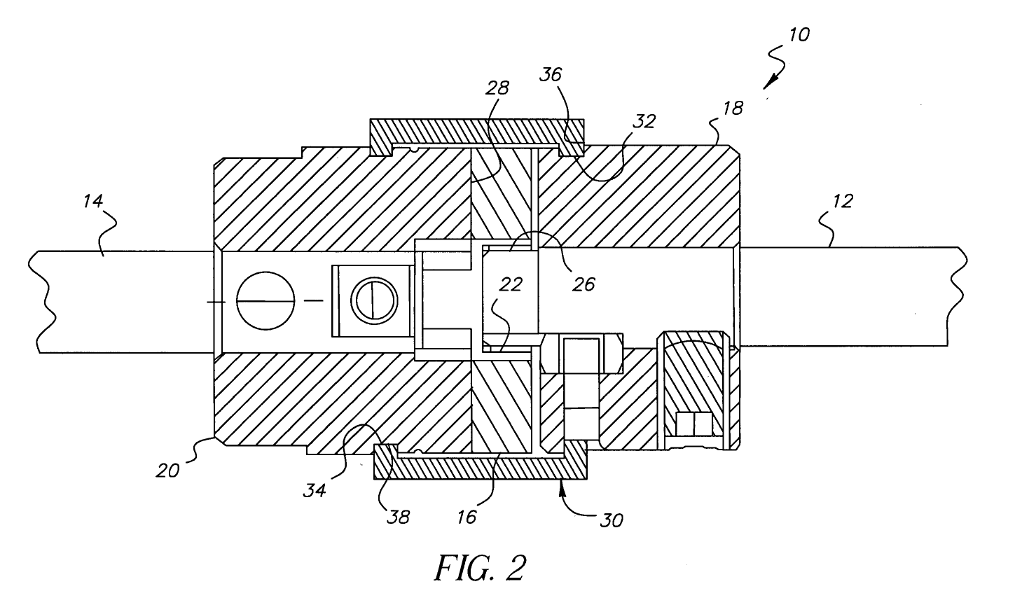

Referring now to the accompanying drawings, the FIGS. 1 and 2 show a coupling, designated generally by the numeral 10, for drivingly connecting a first shaft 12 and a second shaft 14 in a drive train suitable for use with any well-known apparatus where uniform speed output is essential, even when the shafts are misaligned. It may also be desirable that the apparatus with which the drive train is associated be located, and operate, in a non-friendly environment. That is, the environment may be subject to contamination, and specifically, particulate contamination.

The drive coupling 10 for providing uniform speed output with misaligned shafts is generally of the above noted double slider (or Oldham) type. The drive coupling 10 includes a first hub 18, fixed on the end of the first shaft 12, and a second hub 20 fixed on the end of the second shaft 14. Fixing of the hubs 18 and 20 to the respective shafts 12 and 14 may be accomplished in any suitable manner, such as for example the setscrews shown in the figures. A central disk 16 is located in juxtaposition with and between the first hub 18 and the second hub 20.

The central disk 16 has opposing faces with a first feature 22 on one face thereof and a second feature 24 on the opposite face thereof. The second feature 24 is oriented 90° from the first feature 22. The first feature 22 and the second feature 24 are shown as grooves, but could suitably be formed as projections from the respective faces of the central disk 16. The first hub 18 has a feature 26 complimentary to and engageable with the first feature 22 of the central disk 16; and the second hub 20 has a feature 28 complimentary to and engageable with the second feature 24 of the central disk 16. The feature 26 of the first hub 18 and the feature 28 of the second hub 20 are shown as projections, but could suitably be formed as grooves for example, dependent upon the shape of the features of the central disk 16. Furthermore, the central disk 16 is preferably formed of a substantially smooth, relatively hard, plastic-like material, such as Delrin® 500P acetal available from DuPont Corporation located in Wilmington, Del., to reduce friction between the central disk 16 and the hubs 18, 20, as they slide radially relative to one another. By such arrangement, the central disk 16 is capable of sliding radially relative to the first shaft 12 and the second shaft 14 so as to transmit drive to provide uniform speed output even when the first and second shafts are misaligned.

In order to prevent contamination from entering into the cooperating features of the central disk and the hubs, which might adversely impact the desired uniform speed output, the drive coupling 10 includes a protective sleeve 30, according to this invention. The protective sleeve 30 is made of a material that is substantially unaffected by typical contamination byproducts. Moreover, the material of the protective sleeve 30 is flexible. One example of a suitable material for the protective sleeve 30 is polyurethane of a durometer of 50 Shore A, available from Crompton Corporation—Uniroyal Chemical located in Perth Amboy, N.J., under the name of Adiprene® LF 900A. The protective sleeve 30 has lips 32 and 34 formed at the marginal edges thereof. The lips 32, 34 are receivable in retaining grooves respectively formed in hubs 18, 20. With such arrangement, the protective sleeve 30 is retained in intimate contact with the hubs 18, 20 so as to extend, over the central disk 16, in sealing, contaminate-preventing, relationship therebetween. Further, the flexibility of the protective sleeve 30 assures that the protective sleeve will continue to provide the sealing function even when the shafts 12 and 14 are misaligned.

The flexible protective sleeve 30 has another distinct advantageous use according to this invention. The sealing arrangement of the protective sleeve 30 with the hubs 18 and 20, respectively on the ends of the shafts 12 and 14, enables a suitable lubricant to be inserted into the area between the hubs 18 and 20 and the central disk 16 to further reduce any friction therebetween. The protective sleeve 30 acts to effectively contain the lubricant within the drive coupling 10. As such, the lubricant will not leak out of the drive coupling and potentially contaminate the environment of the drive coupling.

The invention has been described in detail with particular reference to certain preferred embodiments thereof, but it will be understood that variations and modifications can be effected within the spirit and scope of the invention.

### PARTS LIST

10 drive coupling

12 first shaft

14 second shaft

16 central disk

18 first hub

20 second hub

22 first central disk feature

24 second central disk feature

26 first hub feature

28 second hub feature

30 protective sleeve

32 lip

34 lip

36 retaining groove

38 retaining groove

1. A coupling for drivingly connecting a first shaft and a second shaft, wherein said coupling includes a central disk capable of sliding relative to said first shaft and said second shaft so as to provide a uniform output speed even when said first shaft and second shaft are misaligned, said coupling comprising:
a protective sleeve extending between, and in sealing relation with, said first shaft and said second shaft, encapsulating said central disk to shield said central disk from contamination, said protective sleeve being formed of a flexible material to accommodate any misalignment between said first shaft and said second shaft.

2. The coupling of claim 1, wherein said protective sleeve is polyurethane.

3. The coupling of claim 1, wherein said protective sleeve has marginal lips respectively engageable with said shafts.

4. A coupling for drivingly connecting a first shaft and a second shaft, said coupling comprising:
an element between said first shaft and said second shaft which provides uniform output speed even when said first and second shafts do not have coincident axes; and
a protective sleeve extending between, and in sealing relation with, said first shaft and said second shaft, encapsulating said element to shield said element from contamination, said protective sleeve being formed of a flexible material to accommodate any misalignment between said first shaft and said second shaft.

5. The coupling of claim 4, wherein said protective sleeve is polyurethane.

6. The coupling of claim 4, wherein said protective sleeve has marginal lips respectively engageable with said shafts.

7. The coupling of claim 4, further including a first hub fixed on the end of said first shaft in juxtaposition with said element, and a second hub fixed on the end of said second shaft in juxtaposition with said element.

8. The coupling of claim 7, wherein said first hub and said second hub respectively have external retaining grooves, and wherein said protective sleeve has marginal lips respectively engageable with said retaining grooves.

9. A coupling for drivingly connecting a first shaft and a second shaft, said coupling comprising:
a central disk between said first shaft and said second shaft capable of sliding relative to said first shaft and said second shaft so as to provide a uniform output speed even when said first shaft and second shaft are misaligned; and
a protective sleeve extending between, and in sealing relation with, said first shaft and said second shaft, encapsulating said central disk to shield said central disk from contamination, and contain a suitable lubricant between said first shaft and said second shaft and said central disk, said protective sleeve being formed of a flexible material to accommodate any misalignment between said first shaft and said second shaft.

10. The coupling of claim 9, wherein said protective sleeve is polyurethane.

11. The coupling of claim 10, further including a first hub fixed on the end of said first shaft in juxtaposition with said central disk, and a second hub fixed on the end of said second shaft in juxtaposition with said central disk.

12. The coupling of claim 11, wherein said first hub and said second hub respectively have external retaining grooves, and wherein said protective sleeve has marginal lips respectively engageable with said retaining grooves.

13. The coupling of claim 10, wherein said central disk has opposing faces with a first feature on one face thereof and a second feature on the opposite face thereof, said second feature oriented 90° from said first feature.

14. The coupling of claim 13, further including a first hub, fixed on the end of said first shaft, having a feature complimentary to and engageable with said first feature of said central disk, and a second hub, fixed on the end of said second shaft, having a feature complimentary to and engageable with said second feature of said central disk.

15. The coupling of claim 14, wherein said central disk is formed of a friction-reducing material so as to facilitate sliding of said central member with respect to said first hub and said second hub.
